(19) United States
(12) Patent Application Publication
(10) Pub. No.: US 2015/0037529 A1
(43) Pub. Date: Feb. 5, 2015

(54) DIPPABLE FLOCK FOR ELASTOMERIC ARTICLES

(71) Applicant: Ansell Limited, Richmond (AU)

(72) Inventors: Liong Yu Loo, Subang Jaya (MY); Kwee Feng Hin, Selangor (MY); Kong Seng Low, Petaling Jaya (MY); Karunagaran A/L Arumugam, Klang (MY)

(21) Appl. No.: 14/331,746

(22) Filed: Jul. 15, 2014

Related U.S. Application Data
(60) Provisional application No. 61/861,537, filed on Aug. 2, 2013.

(51) Int. Cl. B05D 1/16; B05D 7/02; A41D 19/00

(52) U.S. Cl. CPC B05D 1/16; A41D 19/0082; B05D 7/02
USPC 428/90; 427/393.5

(57) ABSTRACT

Provided for example is a method of making an lined elastomeric article comprising: (I) applying to a base elastomer layer a foamed or unfoamed composite of flock fibers and aqueous elastomer, wherein (a) if the elastomer base layer polymer component is (i) not predominantly NR or (ii) not predominantly NR plus NBR, then the elastomer of the composite comprises NBR, wherein NBR and if present acrylic latex are (1) substantial in the composite or (2) predominate in the composite, and/or wherein (b) the elastomer of the composite comprises acrylic latex, NBR and, if the elastomeric base layer is not predominantly NBR, the major elastomer of the base layer.

This application claims the priority of U.S. Provisional Application Ser. No. 61,861,537, filed 2 Aug. 2013, titled Improved Dippable Flock For Elastomeric Articles.

The present application relates generally to improved methods to apply flock to elastomeric articles such as gloves, and the gloves made thereby.

Traditionally, flock fibers are applied to adhesive-coated gloves or other elastomeric articles either mechanically, electro-statically or by a combination of both techniques called pneumatic/electrostatic flocking system.

A current flocking system (refer to FIG. 1) uses windblown mechanical flocking, where an air stream delivers the fibers to an adhesive-coated surface. This method is well established for coating three-dimensional objects such as latex gloves. The system comprises of a flock-feed system, a flocking cabinet & a flock-recycle system. Flock fibers are fed into the flocking cabinet at a rate which is in excess of the rate of flock being taken up on the gloves. Much of the excess flock is recycled to the flock-feed bag, though a considerable amount is carried downstream by the drive mechanism as deposits onto manufacturing equipment such as batons, ovens, machine parts and latex tanks. These equipment deposits contribute to manufacturing rejects.

Electrostatic flocking is a more advanced technique that utilizes a field of static electricity to orient the fibers and promote their perpendicular alignment on the surface on an article. In this method of electro-deposition, the adhesive-coated substrate passes between the potentials of high voltage electrostatic field. An electrode is utilized to give the flock a charge. Charged fibers become aligned with the electric field lines of force. The fibers are electrostatically attracted to the adhesive-coated surface and become embedded into the adhesive-coat with substantial perpendicularly.

Regardless of the level of automation and the type of articles, current manufacturing process are essentially the same, normally comprising the following steps (refer to FIG. 1):—

TABLE
1. Leaching of wet gelled glove onto former;
2. Application of the adhesive;
3. Flocking;
4. Preliminary cleaning (pneumatic removal of excess flock by suction to
minimize flying flock;
5. Drying/curing of adhesive and outer glove layer; and
6. Final cleaning & washing of gloves.

Gloves so manufactured are susceptible to having or shedding too much flock. This is particularly undesirable when the gloves are to be used in food preparation. Thus, manufacturing methods that yield less shedding are desirable. A process that does not use a cloud of flock is desirable for worker safety, worker moral, and for interfering less in the other manufacturing processes. Less loose flock also improves fire safety.

Hassan et al., U.S. Pat. No. 7,037,579 describes a polymer composite coating whereby flock is pre-mixed with elastomer, and dip applied to a base elastomeric article. The Hassan composite solves many of the problems outlined above. However, the Hassan method needs improved adherence of the flock-carrying elastomer to the base elastomer, and improved properties of the flock in the finished article.

### SUMMARY

Provided for example is a method of making an lined elastomeric article comprising: applying to a base elastomer layer a foamed or unfoamed composite of flock fibers and aqueous elastomer, wherein the elastomer of the composite comprises (A) acrylic elastomer, (B) nitrile (NBR) and if the elastomeric base layer is not predominantly NBR, the major elastomer of the base layer.

Further provided is a lined elastomeric article comprising (I) a base elastomer layer; and (II) adhered to the base elastomeric layer a foamed or unfoamed composite of flock fibers and elastomer, wherein the foamed or unfoamed composite elastomer layers against the base elastomer layer and flock extends away from the base and composite elastomers, wherein the elastomer of the composite comprises (A) acrylic latex, (B) NBR and (C), if the elastomeric base layer is not predominantly NBR, the major elastomer of the base layer.

Also provided is a method of making an lined elastomeric article comprising: (I) applying to a base elastomer layer a foamed or unfoamed composite of flock fibers and aqueous elastomer, wherein (a) if the elastomer base layer polymer component is (i) not predominantly NR or (ii) not predominantly NR plus NBR, then the elastomer of the composite comprises NBR, wherein NBR and if present acrylic latex are (1) substantial in the composite or (2) predominate in the composite, and/or wherein (b) the elastomer of the composite comprises acrylic latex, NBR and, if the elastomeric base layer is not predominantly NBR, the major elastomer of the base layer.

Further provided is a lined elastomeric article comprising: (I) a base elastomer layer; and (II) adhered to the base elastomeric layer a foamed or unfoamed composite of flock fibers and elastomer, wherein the foamed or unfoamed composite elastomer layers against the base elastomer layer and flock extends away from the base and composite elastomers, wherein (a) if the elastomer base layer polymer component is (i) not predominantly NR or (ii) not predominantly NR plus NBR, then the elastomer of the composite comprises NBR, wherein NBR and if present acrylic latex are (1) substantial in the composite or (2) predominate in the composite, and/or wherein (b) the elastomer of the composite comprises acrylic latex, NBR and, if the elastomeric base layer is not predominantly NBR, the major elastomer of the base layer.

Also provided is a method of making an lined elastomeric article comprising applying to an elastomeric base layer a foamed or unfoamed composite of liner flock fibers and aqueous elastomer, wherein the flock fibers include hydrophobic fibers and hydrophilic fibers.

Still further provided is a lined elastomeric article comprising a base elastomer layer; and adhered to the base elastomeric layer a foamed or unfoamed composite of flock fibers and elastomer, wherein the foamed or unfoamed composite elastomer layers against the base elastomer layer and flock extends away from the base and composite elastomers, wherein the flock fibers include hydrophobic fibers and hydrophilic fibers.

### DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only illustrative embodiments of this invention and are therefore not to be considered limiting of its scope, for the invention may admit to other equally effective embodiments.

FIG. 1 depicts a current method of applying flock;

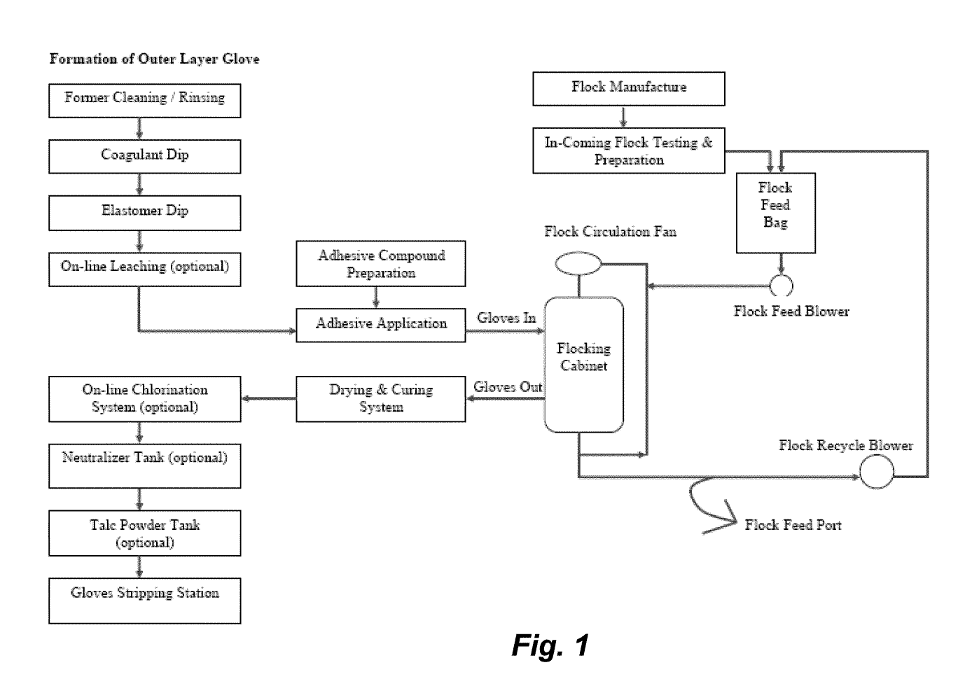

FIG. 2 shows a method of applying flock that uses a composite of flock and elastomer; and

FIG. 3 shows a schematic cross-section of a flocked elastomeric article.

FIG. 4 shows a schematic cross-section of a flocked and foamed elastomeric article.

FIG. 5A shows a cross-section of a lining according to the invention, while FIG. 5B shows a cross-section of a flock lining obtained using a flocking cabinet. In the lower left of each figure is a dark solid bar representing approximately 0.2 mm.

FIG. 6 illustrates in cross-section an open foam layer with a useful porosity (no flock fiber present). Below the figure is a white solid bar representing approximately 500 micrometers.

To facilitate understanding, identical reference numerals have been used, where possible, to designate comparable elements that are common to the figures. The figures are not drawn to scale and may be simplified for clarity. It is contemplated that elements and features of one embodiment may be beneficially incorporated in other embodiments without further recitation.

### DETAILED DESCRIPTION

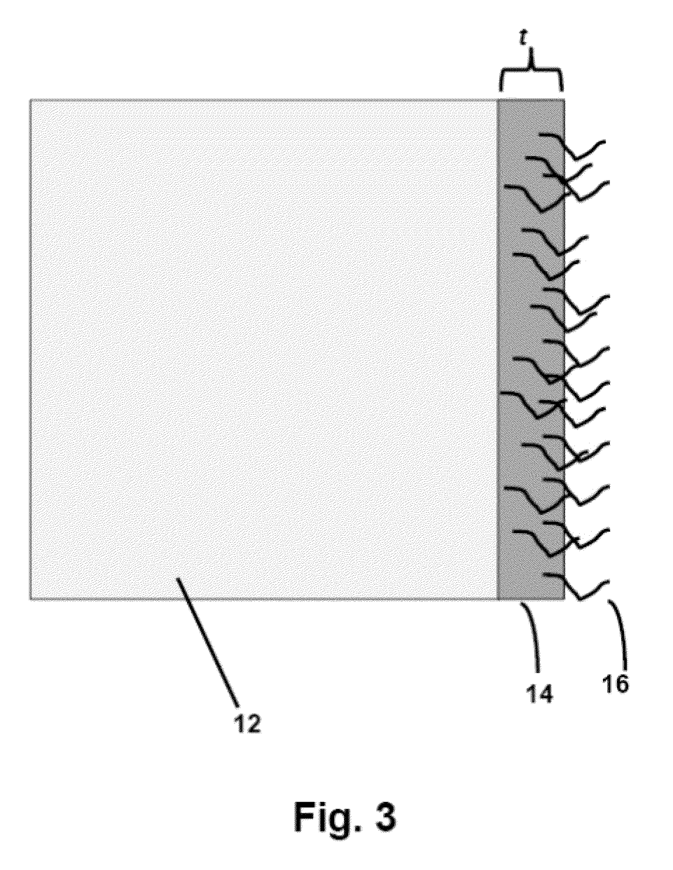

FIG. 3 shows a cross-section of an elastomeric article of the invention wherein a base elastomer layer 12 and a composite elastomer layer 14. composite elastomer layer 14 includes flock 16, but is measured for thickness of the composite elastomer layer 14 t as illustrated. There can be additional layers or coatings to the left side of the illustrated base layer 12. The flock is typically, but not always, the interior layer of an article.

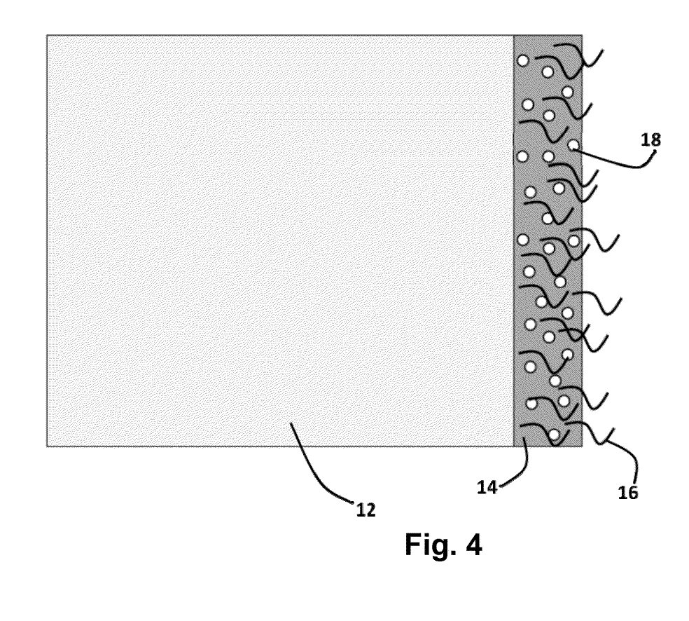

In FIG. 4, the composite elastomer layer 14 is foamed. The foam is schematically represented, and can be a closed or open foam.

The flock is shown extending away from the base and composite elastomer, as will be visually apparent. This extension does not mean that the flock extended away has no adherent elastomer, but that visually the extended flock is distinct from the layer of composite elastomer adhered to the base elastomer.

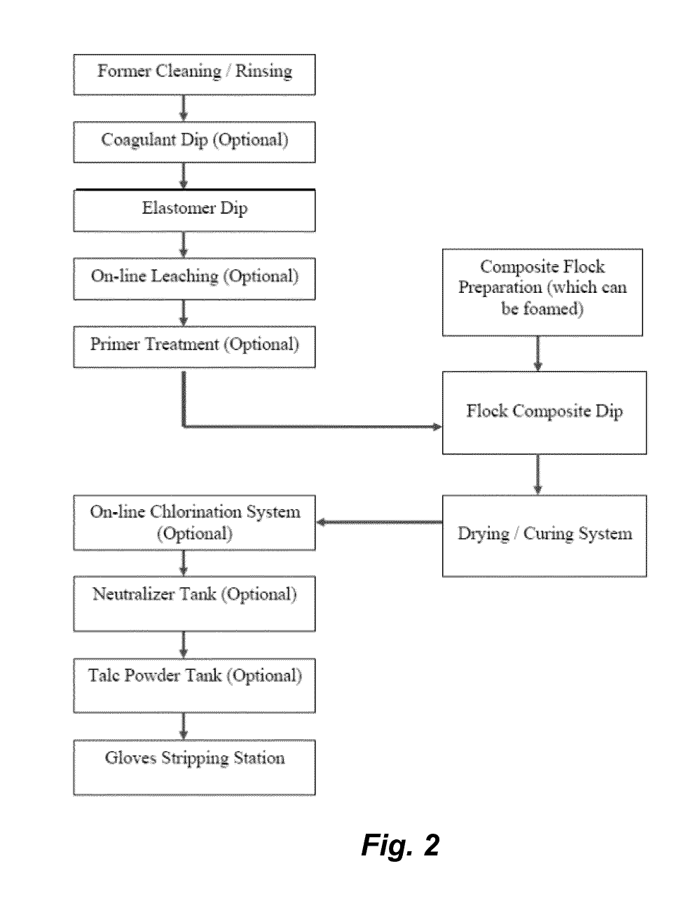

In the process illustrated in FIG. 2, the coagulant dip is optional. For example, for thin articles it can be omitted. The elastomer dip can be made up of one dipping step, or multiple dips, optionally with one or more coagulant dips between elastomer dips. If the elastomer composition has not materially changed from one dip to a successive dip, the elastomer formed of two or more such successive dips is deemed a single layer.

In one embodiment, it has been discovered that the flock properties of the finished article can be improved if the flock consists of a mixture of hydrophilic and hydrophobic flock, such as hydrophilic and hydrophobic cotton flocks. The flock mixture can be either natural (such as cotton) or synthetic flock (such as rayon; acrylic; nylon; polyester, etc) fibers as long as it is a mixture of hydrophilic and hydrophobic flocking materials with flock-property improving proportions. Hydrophilic flock fibers have strong affinity for water, comparable to the affinity of unmodified cotton flock for water. Hydrophobic flock means the flock has little or no affinity for water, comparable to the affinity for water of treated cotton flock and/or other hydrophobic synthetic flock fibers,

It has been unexpectedly found that the mixture of the two types of flock provides a high density, deep embedding of flock, believed substantially due to the hydrophilic flock, and a density of partially embedded flocks on the latex surface, believed substantially due to the hydrophobic flock. The combination, thus, provides a high density flock with good extension from the embedding elastomer. The embedding elastomer adheres to the underlying base elastomeric layer.

In embodiments, the flock composition comprises about 0.5 to about 15% wt. of hydrophobic flock (e.g., 2.25% or 3.6%), and about 0.5 to about 10% wt. of hydrophilic flock (e.g., 1.25% or 2.00%). The fiber length depends on cut flocks or milled flocks. Cut flocks (supplied in precision cut length) can be, in embodiments, about 0.3 mm to about 5 mm (average) in length, such as about 0.5 mm to about 2.0 mm. Milled flock (produced from spinning waste or textile waste) can be, in embodiments, about 0.4 to about 1.1 mm (average), such as about 0.2 to 0.5 mm length.

In another embodiment, if the base layer is predominantly natural rubber (NR) or a mixture of NR/NBR, it has been found that to obtain an improved resistance to peeling off from the base elastomer layer, one can use as the flock carrier elastomer of the composite elastomer a mixture of NR (natural rubber), NBR (nitrile, i.e., acrylonitrile butadiene copolymer) and acrylic elastomer. If the base elastomer is not predominantly NR or a mixture of NR/NBR, the flock carrier can be NBR or NBR plus acrylic elastomer. By “base” layer it is meant the layer of the article to which the fiber composite is applied. An acrylic latex can be, for example, based on methacrylate, methyl acrylate, ethyl acrylate, 2-ethylhexyl acrylate, hydroxyethyl methacrylate, butyl acrylate, butyl methacrylate, mixtures thereof, and the like. In embodiments, the acrylic used is Poly 88 (Bio Cosmic Sdn Bhd, Malaysia) or another such acrylic polymer dispersion specially formulated to provide a smooth donning surface to the base layer.

An elastomer is predominant in a layer if its content is more than 50% by weight of polymers of compound mix. The major elastomer in a layer is that with the highest % value. An elastomer or combination of elastomers is a substantial portion of the elastomer of a layer if it or they combine to more than 10% or more by weight of polymers of compound mix.

The mixture of the two or three elastomers is in an amount that improves one or both of flock adherence, or composite layer adherence to the base layer. In embodiments where the invention calls for two elastomers, the composition can be, as a percentage of flock composite formulation including water (as used for application):

TABLE

| | (% wt.) | OR |
|---|---|---|
| NBR | about 0.5 to 30 | about 1 to 10 |
| Acrylic | about 0.1 to 10 | about 0.2 to 5 |
| Other elastomers | to about 5 | |

In embodiments where the invention calls for three elastomers, the composition can be, as a percentage of flock composite formulation including water (as used for application):

TABLE

| | (% wt.) | OR |
|---|---|---|
| NBR | about 0.5 to 20 | about 1 to 10 |
| Acrylic | about 0.1 to 10 | about 0.2 to 5 |
| Base layer elastomer | about 3 to 50 | about 5 to 20 |
| Other elastomers | to about 5 | |

In embodiments, the base layer is formed of NR, polychloroprene (CP), NBR (such as carboxylated or non-carboxylated acrylonitrile butadiene copolymer), polyisoprene (PI), polyurethane (PU), styrene-butadiene, butyl rubber (copolymer of isobutylene with isoprene, or polymer of isobutylene), or a combination thereof. In embodiments, the base layer is formed of CP, NBR or combinations thereof. In embodiments, the base layer is formed of NR.

The process used to form the base layer can be conventional, as illustrated in the Elastomer Dip and On-line Leaching steps of FIG. 2. The indicated Primer Treatment step is to further assure that the flock layer well adheres to the base layer, with the cotton flock anchored in the flock layer and giving a good donning sensation. Compositions for primer treatment can include for example calcium nitrate solution (e.g., about 6% wt.).

Flock is mixed with aqueous elastomer (latex) in the Composite Flock step and applied to the base layer in the Dip-flock Composite step. Application is by a dipping process, typically on a gelled, uncured base layer. The article is typically then cured in the Curing step. A lower temperature drying can be applied before curing. Thereafter, the optional steps set forth in FIG. 2 can be applied. Prior to use, the article is stripped off of the former.

In embodiments of the invention, the base elastomer layer is about 2 mil (0.051 mm) to about 40 mil (1.02 mm), such as about 14 mil (0.356 mm).

In embodiments, the composite (flock carrier) elastomer layer (adhered to the base) 18 is about 0.5 mil (0.013 mm) to about 4 mil (0.102 mm) thick, such as about 1 mil (0.025 mm) to about 2 mil (0.051 mm). The composite elastomer layer thickness is measured with respect to elastomer, which layers against the base layer, without measuring flock extended from the elastomer.

The composite elastomer can be foamed.

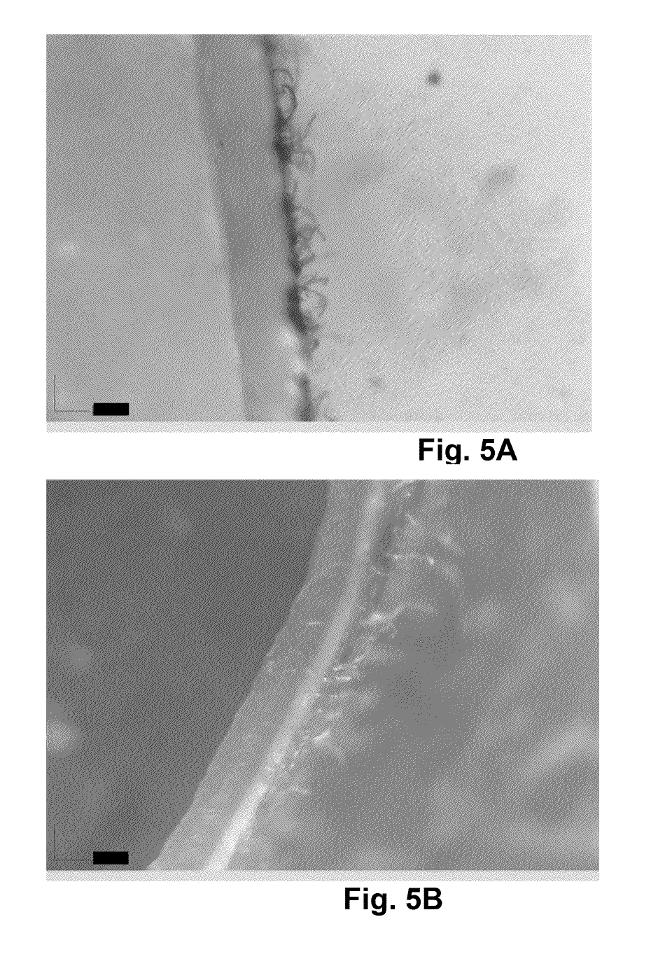

The process can obtain a thickness composite elastomer layer 14 t that is surprisingly thin, such as about 0.5 mill (0.013 mm) or less. The thickness obtainable with the current process is illustrated in FIG. 5A, as compared to a thickness obtained with a flocking cabinet process, FIG. 5B. In FIG. 5B, the flocking layer polymer is the very apparent white layer. In FIG. 5A, the layer is not so apparent, due to its small thickness.

Micronized lubricant waxes such as high density polyethylene (“HDPE”), polypropylene, carnauba, hydrocarbon or polytetrafluoroethylene (“PTFE”) provide some degree of smoothness and lubricity to the composite lining for ease of donning, especially when the coating is foamed. Micronized waxes can improve flow behavior in aqueous flock dispersions used in the present invention. Waxes useful in the various embodiments of the polymer fibrous composite of the present invention can be of natural or synthetic origin. Synthetic waxes include polymer and copolymer waxes, for example, polyethylene wax, oxidized polyethylene wax, modified polyethylene wax, high density polyethylene wax, oxidized high density polyethylene wax, modified high density polyethylene wax, polypropylene wax, polyamide wax, polytetrafluoroethylene wax, and the like. Useful natural waxes include, for example, carnauba wax, microcrystalline wax, paraffin wax, and the like. One useful micronized HDPE wax is ACUMIST D9 available from Honeywell International, Specialty Wax and Additives, USA.

Surfactants such as nonionic acetylenic diols and ethoxylated acetylenic diols are useful in the various embodiments of the polymer fibrous composite of the present invention. One useful surfactant is SURFYNOL 465 available from Air Products and Chemicals Inc., USA. Another surfactant is Darvan WAQ/lauryl alcohol solution of sodium alkyl sulfates, R.T. Vanderbilt Holding Company, Inc., Norwalk, Conn., USA. Another useful surfactant is potassium laurate.

Without being bound by theory, it is believed that the presence of a fatty alcohol, such as lauryl or myristyl alcohol, aids in stabilizing the foam structure. In embodiments, the amount of such alcohol in the composite flock formulation is from about 0.1 to about 2.0%.

Without being bound by theory, it is believed that the presence of a fatty tertiary amine oxide, such as lauramine oxide or myristamine oxide (N,N-Dimethyltetradecan-1-amine oxide), aids in stabilizing the foam structure. In embodiments, the amount of such amine oxide in the composite flock formulation is from about 1 to about 3 phr.

Foaming and frothing agents are useful in the various embodiments of the polymer fibrous composite of the present invention. Useful commercial foaming agents include for example EMPIGEN OB (amine oxide, namely lauramine oxide) available from Huntsman Performance Products, Woodlands, Tex., USA, and EMULVIN W from Bayer AG, Germany.

Additives, such as thickeners (viscosity modifiers), curatives or curing agents can be used in the various embodiments of the polymer fibrous composite of the present invention. For example, triethanolamine can be used along with the surfactants of the present invention. One exemplary useful thickener is ACRYSOL G 111 available from Rohm and Haas (UK) Ltd., United Kingdom. PEG 3350 is available from ICI Australia Operations Pty Ltd. CELLOSIZE is available from Union Carbide (Europe) S.A., Belgium. COMPOSITE A345 is available from Aquaspersion Ltd., United Kingdom. SCRIPSET 550 is available from Monsanto Chemical Co., USA. CELLOSIZE 30000 is available from Dow Construction Chemicals, USA.

WEBNIX FREESIL N, an exemplary useful defoamer, is available from Crusader Chemical Co., USA. NIPACIDE TK, an exemplary useful biocide, is available from Nipa Laboratories Ltd., Wales, United Kingdom. Pigments can be used in the practice of the present invention such as titanium oxide and color dispersions; TEGO 4710 is available from Goldschmidt AG, Germany; Octotint 708 is available from Excelkos Sdn Bhd, Malaysia; Farsperse White, available from Farben Technique (M) Sdn Bhd, Malysia. One useful curative is zinc diethyldithiocarbamate (“ZDEC”). Other useful commercial additives include ammonia, sodium lauryl sulfate, sodium dodecylbenzene sulfate, sodium dibenzyl sulfonate, and potassium hydroxide solution, that can be used as stabilizers.

Triethanolamine, metal hydroxides (e.g., KOH), or the like can be used for pH adjustment. Fillers, such as minerals, including thixotropic fillers such as bentonite (e.g., OPTIGEL CK solution from Rockwood Additives Limited, UK), can be added. Thixotropic fillers are particularly useful for foamed fiber composite compositions. In embodiments, the amount of such thixotropic filler in the composite flock formulation is from about 0.2 to about 3 phr, or about 0.3 to about 1 phr.

A useful NBR composition is the SYNTHOMER X6311 45% composition available from Synthomer Limited, Harlow, UK. A useful acrylic elastomer composition is the Poly-88 available from Bio Cosmic in Malaysia.

In embodiments, one or more of the elastomeric layers (12, 16) have density consistent with aqueous latex dipping (as opposed for example to a density consistent with injection molding). In certain embodiments, the barrier layers have other properties (such as elasticity) consistent with aqueous latex dipping. These densities or other properties can vary with the polymer content of the elastomeric layers.

Articles that can be made according to the invention include, for example, gloves, booties, other protective articles of clothing, other dipped latex products, and the like.

The elastomer compositions will typically include vulcanization promoting chemicals, such as sulfur, accelerators such as zinc diethyldithiocarbamate, activators such as ZnO, and the like.

For the fiber composite composition, useful viscosities are from about 40 to about 120 cPs, such as about 75-100 cPs. A useful pH is elevated, such as about 9 to about 12.5, such as about 10-12. A useful total solids content is about 5% to about 35%, such as about 10-20%.

Thixotropic agents such as bentonite can be included, particularly for foamed applications.

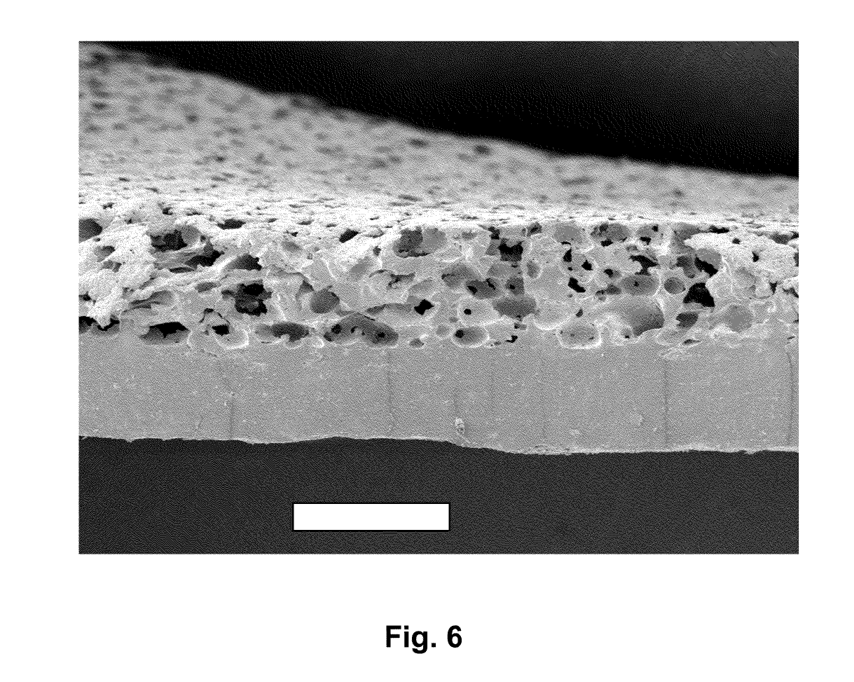

If the fiber composite composition is foamed, in embodiments it is foamed to about 10% (v/v) to about 60% air, preferably about 15% to about 35%. In embodiments, the post-curing air content is about 3% to about 60%. In other embodiments, incorporating a more closed cell foam structure, the post-curing air content is about 3% to about 45%, preferably about 10% to about 20%. In other embodiments, incorporating a more open cell foam structure, the post-curing air content is about 3% to about 60%, preferably about 15% to about 35%. In high air content embodiments, the porosity can be comparable to that shown in FIG. 6. FIG. 6 shows in cross-section an open foam layer of about 380 micrometers thickness, formed on a non-foamed layer of about 330 micrometers. The cross-section was made by Stereo Microscope, and the photograph of FIG. 6 made by scanning electron microscopy after appropriate sample preparation.

In embodiments, the flock is mixed with surfactant, water, triethanolamine and wax and stirred. Thereafter, elastomers, further water, and additional components are mixed with the flock.

After forming the lined article, chlorination can be conducted at 0.5 g/L. Tumbling wash action can aide in removing excess or loose flock.

All ranges recited herein include ranges therebetween, and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4, . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4 or more, or 3.1 or more.

### Example 1

An exemplary composition, particularly for use without foaming, is:

| | | | | Actual | Actual |
|---|---|---|---|---|---|
| TSC/ | | Dry/ | Wet/ | weight | weight |
| % | Ingredients | phr | phr | wet/g | dry/g |
| 0 | Water | 0.00 | 47.07 | 4471.65 | 0.00 |
| 25 | SDBS | .05 | 0.20 | 19.00 | 4.75 |
| 100 | TEA | .37 | 0.37 | 35.15 | 35.15 |
| | Triethanolamine | | | | |
| 100 | Acumist D-9 100% | .80 | 0.80 | 76.00 | 76.00 |
| 100 | Hydrophobic Cotton | .25 | 2.25 | 213.75 | 213.75 |
| | Flock (Starfloc) | | | | |
| 100 | Hydrophilic Cotton | .25 | 1.25 | 118.75 | 118.75 |
| | Flock (Glamorcote) | | | | |
| 0 | Water | .00 | 9.41 | 893.95 | 0.00 |
| 25 | SDBS | .15 | 0.60 | 57.00 | 14.25 |
| 20 | Poly 88 | .38 | 1.88 | 178.60 | 35.72 |
| 43 | Synthomer 6311 | .69 | 6.25 | 593.75 | 255.31 |
| 60 | Natural Rubber | .50 | 7.50 | 712.50 | 427.50 |
| 10 | KOH | .15 | 1.50 | 142.50 | 14.25 |
| 70 | Octotint 708/ | .63 | 3.75 | 356.25 | 249.38 |
| | Farsperse White | | | | |
| 50 | Nipacide TK | .25 | 0.50 | 47.50 | 23.75 |
| 1.5 | Cellusize | .25 | 16.67 | 1583.65 | 23.75 |
| | Total | 5.72 | 100.00 | 9500.00 | 1492.31 |

### Example 2

Another exemplary composition, particularly for use with foaming, is:

| | | | | Actual | Actual |
|---|---|---|---|---|---|
| | | Dry | Wet | Dry | Wet |
| | TSC | (% by | (% by | Weight | Weight |
| Ingredients | (%) | Weight) | Weight) | (g) | (g) |
| Water | 0 | 0.000 | 35.800 | 0.00 | 5000.00 |
| SDBS 25% | 25 | 0.081 | 0.324 | 11.25 | 45.00 |
| TEA Triethanolamine | 100 | 0.322 | 0.322 | 45.00 | 45.00 |
| 100% | | | | | |
| Acumist D-9 100% | 100 | 0.688 | 0.688 | 96.00 | 96.00 |
| Hydrophobic Cotton | 100 | 1.930 | 1.930 | 270.00 | 270.00 |
| Flock 100% (Starfloc) | | | | | |
| Hydrophilic Cotton | 100 | 1.074 | 1.074 | 150.00 | 150.00 |
| Flock 100% | | | | | |
| (Glamorcote) | | | | | |
| Water | 0 | 0.000 | 7.163 | 0.00 | 1000.00 |
| SDBS 25% | 25 | 0.090 | 0.360 | 12.00 | 48.00 |
| Poly 88 20% (Acrylic) | 20 | 0.215 | 1.075 | 30.00 | 150.00 |
| Synthomer 6311 45% | 45 | 1.930 | 4.289 | 270.00 | 600.00 |
| (NBR) | | | | | |
| Natural Rubber 60% | 60 | 10.740 | 17.900 | 1500.00 | 2500.00 |
| Darwan WAQ/Lauryl | 14 | 0.373 | 2.664 | 52.08 | 372.00 |
| alcohol solution | | | | | |
| Empigen OB solution | 31.3 | 0.306 | 0.978 | 42.76 | 136.60 |
| Optigel CK solution | 7.6 | 0.100 | 1.316 | 13.98 | 184.00 |
| Potassium Laurate 10% | 10 | 0.043 | 0.430 | 6.00 | 60.00 |
| KOH 10% | 10 | 0.115 | 1.150 | 16.00 | 160.00 |
| Sulphur 50% | 50 | 0.09 | 0.180 | 12.50 | 25.00 |
| (From ASA) | | | | | |
| ZDEC 50% (From ASA) | 50 | 0.09 | 0.180 | 12.50 | 25.00 |
| ZnO 50% (From ASA) | 50 | 0.125 | 0.250 | 17.50 | 35.00 |
| Nipacide TK 50% | 50 | 0.215 | 0.430 | 30.00 | 60.00 |
| Cellusize 30,000 2% | 2 | 0.287 | 14.350 | 40.00 | 2000.00 |
| Water | 0 | 0.000 | 7.163 | 0.00 | 1000.00 |
| Total | | 18.82 | 100.016 | 2627.57 | 13961.60 |

### Example 3

Another exemplary composition, particularly for use without foaming on NBR gloves, particularly gloves formulated for cold temperature use, is:

| | | | | ACTUAL | | |
|---|---|---|---|---|---|---|
| | | DRY | WET | WET | ACTUAL | |
| TSC | | (% By | (% By | WEIGHT | DRY | Scale-up |
| (%) | INGREDIENT | Weight) | Weight) | (g) | WEIGHT | factor: |
| | Water | 0.00 | 48.01 | 3601.01 | 0.00 | 57.61612 |
| | SDBS | 0.04 | 0.15 | 11.52 | 0.05 | 57.61612 |
| | TEA | 0.28 | 0.28 | 21.32 | 0.37 | 57.61612 |
| | Acumist D-9 | 0.61 | 0.61 | 46.09 | 0.80 | 57.61612 |
| | Hydrophobic cotton | 1.73 | 1.73 | 129.64 | 2.25 | 57.61612 |
| | flock | | | | | |
| | (Glamorcote Flock; | | | | | |
| | Glamorcote (Pg) Sdn | | | | | |
| | Bhd, Penang, Malaysia) | | | | | |
| | Hydrophilic cotton flock | 0.96 | 0.96 | 72.02 | 1.25 | 57.61612 |
| | (Star Flock, Golden | | | | | |
| | Years Domestic Maker | | | | | |
| | Sdn Bhd, Padang Serai, | | | | | |
| | Malaysia) | | | | | |
| | Premix | | | | | |
| | Water | 0.00 | 9.60 | 720.20 | 0.00 | 57.61612 |
| | SDBS | 0.12 | 0.46 | 34.57 | 0.15 | 57.61612 |
| | Poly 88 | 0.29 | 1.46 | 109.47 | 0.38 | 57.61612 |
| | Nipol LX554 (NBR, | 7.68 | 17.07 | 1280.23 | 10.00 | 57.61612 |
| | Xeon Corp., Tokyo, JP) | | | | | |
| | KOH | 0.12 | 2.30 | 172.85 | 0.15 | 57.61612 |
| | ZnO2 | 0.12 | 0.23 | 17.28 | 0.15 | 57.61612 |
| | Sulphur | 0.06 | 0. | 64 | 0.08 | 57.61612 |
| | ZDEC | 0.05 | 0.09 | 6.91 | 0.06 | 57.61612 |
| | ZMBT | 0.08 | 0.15 | 11.52 | 0.10 | 57.61612 |
| | Octotint 708 | 2.02 | 2.89 | 216.64 | 2.63 | 57.61612 |
| | Scripset 550 | 0.08 | 0.68 | 50.70 | 0.10 | 57.61612 |
| | Nipacide TK | 0.19 | 0.38 | 28.81 | 0.25 | 57.61612 |
| | Cellosize | 0.19 | 12.81 | 960.46 | 0.25 | 57.61612 |
| | Total | 14.61 | 100.00 | 7500.00 | 19.02 | |

The invention further includes the following embodiments:

### Embodiment A

A method of making an lined elastomeric article comprising applying to a base elastomer layer a foamed or unfoamed composite of flock fibers and aqueous elastomer, wherein the elastomer of the composite comprises (A) acrylic elastomer, (B) NBR and (C) if the elastomeric base layer is not predominantly NBR, the major elastomer of the base layer.

### Embodiment B

The method of Embodiment A, wherein the elastomeric base layer is predominantly natural rubber.

### Embodiment C

The method of Embodiment A, wherein the elastomeric base layer is predominantly NBR.

### Embodiment D

The method of Embodiment A, wherein the elastomeric base layer substantially CP, NBR or combinations thereof.

### Embodiment E

The method of Embodiment A, B, C or D (i.e., A-D), wherein the flock fibers include hydrophobic fibers and hydrophilic fibers.

### Embodiment F

The method of Embodiment. A-E, further comprising thereafter curing the base elastomer layer and the composite elastomer layer.

### Embodiment G

The method of Embodiment. A-F, further comprising treating the based layer with a primer prior to applying the fiber composite.

### Embodiment AA

A lined elastomeric article comprising (I)) a base elastomer layer; and (II) adhered to the base elastomeric layer a foamed or unfoamed composite of flock fibers and elastomer, wherein the foamed or unfoamed composite elastomer layers against the base elastomer layer and flock extends away from the base and composite elastomers, wherein the elastomer of the composite comprises acrylic latex, NBR and, if the elastomeric base layer is not predominantly NBR, the major elastomer of the base layer.

### Embodiment AB

The lined elastomeric article of Embodiment AA, wherein the elastomeric base layer is predominantly natural rubber.

### Embodiment AC

The lined elastomeric article of Embodiment AA, wherein the elastomeric base layer is predominantly NBR.

### Embodiment AD

The lined elastomeric article of Embodiment AA, wherein the elastomeric base layer substantially CP, NBR or combinations thereof.

### Embodiment AE

The lined elastomeric article of Embodiment AA-AD, wherein the flock fibers include hydrophobic fibers and hydrophilic fibers.

### Embodiment BA

A method of making an lined elastomeric article comprising applying to an elastomeric base layer a foamed or unfoamed composite of liner flock fibers and aqueous elastomer, wherein the flock fibers include hydrophobic fibers and hydrophilic fibers.

### Embodiment BB

The method of Embodiment BA, wherein the elastomeric base layer is predominantly natural rubber.

### Embodiment BC

The method of Embodiment BA, wherein the elastomeric base layer is predominantly NBR.

### Embodiment BD

The method of Embodiment BA, wherein the elastomeric base layer substantially CP, NBR or combinations thereof.

### Embodiment BE

The method of Embodiment BA-BD, further comprising treating the based layer with a primer prior to applying the fiber composite.

### Embodiment CA

A lined elastomeric article comprising (A) a base elastomer layer; and (B) adhered to the base elastomeric layer a foamed or unfoamed composite of flock fibers and elastomer, wherein the foamed or unfoamed composite elastomer layers against the base elastomer layer and flock extends away from the base and composite elastomers, wherein the flock fibers include hydrophobic fibers and hydrophilic fibers.

### Embodiment CB

The lined elastomeric article of Embodiment CA, wherein the elastomeric base layer is predominantly natural rubber.

### Embodiment CC

The lined elastomeric article of Embodiment CA, wherein the elastomeric base layer is predominantly NBR.

### Embodiment CD

The lined elastomeric article of Embodiment CA, wherein the elastomeric base layer substantially CP, NBR or combinations thereof.

### Embodiment 1

A method of making an lined elastomeric article comprising: (I) applying to a base elastomer layer a foamed or unfoamed composite of flock fibers and aqueous elastomer, wherein (a) if the elastomer base layer polymer component is (i) not predominantly NR or (ii) not predominantly NR plus NBR, then the elastomer of the composite comprises NBR, wherein NBR and if present acrylic latex are (1) substantial in the composite or (2) predominate in the composite, and/or wherein (b) the elastomer of the composite comprises acrylic latex, NBR and, if the elastomeric base layer is not predominantly NBR, the major elastomer of the base layer.

### Embodiment 2

The method of embodiment 1, wherein the elastomeric base layer is predominantly natural rubber.

### Embodiment 3

The method of embodiment 1 or 2, wherein the elastomeric base layer is predominantly NBR.

### Embodiment 4

The method of one of embodiments 1-3, wherein the elastomeric base layer substantially CP, NBR or combinations thereof.

### Embodiment 5

The method of one of embodiments 1-4, wherein the flock fibers include hydrophobic fibers and hydrophilic fibers.

### Embodiment 6

The method of one of embodiments 1-5, further comprising thereafter curing the base elastomer layer and the composite elastomer layer.

### Embodiment 7

The method of one of embodiments 1-6, further comprising treating the based layer with a primer prior to applying the fiber composite.

### Embodiment 8

A lined elastomeric article comprising: (I) a base elastomer layer; and (II) adhered to the base elastomeric layer a foamed or unfoamed composite of flock fibers and elastomer, wherein the foamed or unfoamed composite elastomer layers against the base elastomer layer and flock extends away from the base and composite elastomers, wherein (a) if the elastomer base layer polymer component is (i) not predominantly NR or (ii) not predominantly NR plus NBR, then the elastomer of the composite comprises NBR, wherein NBR and if present acrylic latex are (1) substantial in the composite or (2) predominate in the composite, and/or wherein (b) the elastomer of the composite comprises acrylic latex, NBR and, if the elastomeric base layer is not predominantly NBR, the major elastomer of the base layer.

### Embodiment 9

The lined elastomeric article of embodiment 8, wherein the elastomeric base layer is predominantly natural rubber.

### Embodiment 10

The lined elastomeric article of one of embodiments 8-9, wherein the elastomeric base layer is predominantly NBR.

### Embodiment 11

The lined elastomeric article of one of embodiments 8-10, wherein the elastomeric base layer substantially CP, NBR or combinations thereof.

### Embodiment 12

The lined elastomeric article of one of embodiments 8-11, wherein the flock fibers include hydrophobic fibers and hydrophilic fibers.

### Embodiment 13

A method of making an lined elastomeric article comprising: applying to an elastomeric base layer a foamed or unfoamed composite of liner flock fibers and aqueous elastomer, wherein the flock fibers include hydrophobic fibers and hydrophilic fibers.

### Embodiment 14

The method of embodiment 13, wherein the elastomeric base layer is predominantly natural rubber.

### Embodiment 15

The method of one of embodiments 13-14, wherein the elastomeric base layer is predominantly NBR.

### Embodiment 16

The method of one of embodiments 13-15, wherein the elastomeric base layer substantially CP, NBR or combinations thereof.

### Embodiment 17

The method of one of embodiments 13-16, further comprising treating the based layer with a primer prior to applying the fiber composite.

### Embodiment 18

A lined elastomeric article comprising: (I) a base elastomer layer; and (II) adhered to the base elastomeric layer a foamed or unfoamed composite of flock fibers and elastomer, wherein the foamed or unfoamed composite elastomer layers against the base elastomer layer and flock extends away from the base and composite elastomers, wherein the flock fibers include hydrophobic fibers and hydrophilic fibers.

### Embodiment 19

The lined elastomeric article of embodiment 18, wherein the elastomeric base layer is predominantly natural rubber.

### Embodiment 20

The lined elastomeric article of one of embodiments 18-19, wherein the elastomeric base layer is predominantly NBR.

### Embodiment 21

The lined elastomeric article of one of embodiments 18-20, wherein the elastomeric base layer is substantially CP, NBR or combinations thereof.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

What is claimed is:

1. A method of making an lined elastomeric article comprising
applying to a base elastomer layer a foamed or unfoamed composite of flock fibers and aqueous elastomer,
wherein (a) if the elastomer base layer polymer component is (i) not predominantly NR or (ii) not predominantly NR plus NBR, then the elastomer of the composite comprises
NBR, wherein NBR and if present acrylic latex are substantial in the composite,
and/or wherein (b) the elastomer of the composite comprises
acrylic latex,
NBR and,
if the elastomeric base layer is not predominantly NBR, the major elastomer of the base layer.

2. The method of claim 1, wherein the elastomeric base layer is predominantly natural rubber.

3. The method of claim 1, wherein the elastomeric base layer is predominantly NBR.

4. The method of claim 1, wherein the elastomeric base layer substantially CP, NBR or combinations thereof.

5. The method of claim 1, wherein the flock fibers include hydrophobic fibers and hydrophilic fibers.

6. The method of claim 1, further comprising thereafter curing the base elastomer layer and the composite elastomer layer.

7. The method of claim 1, further comprising treating the based layer with a primer prior to applying the fiber composite.

8. A lined elastomeric article comprising
a base elastomer layer; and
adhered to the base elastomeric layer a foamed or unfoamed composite of flock fibers and elastomer, wherein the foamed or unfoamed composite elastomer layers against the base elastomer layer and flock extends away from the base and composite elastomers,
wherein (a) if the elastomer base layer polymer component is (i) not predominantly NR or (ii) not predominantly NR plus NBR, then the elastomer of the composite comprises
NBR, wherein NBR and if present acrylic latex are substantial in the composite,
and/or wherein (b) the elastomer of the composite comprises
acrylic latex,
NBR and,
if the elastomeric base layer is not predominantly NBR, the major elastomer of the base layer.

9. The lined elastomeric article of claim 8, wherein the elastomeric base layer is predominantly natural rubber.

10. The lined elastomeric article of claim 8, wherein the elastomeric base layer is predominantly NBR.

11. The lined elastomeric article of claim 8, wherein the elastomeric base layer substantially CP, NBR or combinations thereof.

12. The lined elastomeric article of claim 8, wherein the flock fibers include hydrophobic fibers and hydrophilic fibers.

13. A lined elastomeric article comprising
a base elastomer layer; and
adhered to the base elastomeric layer a foamed or unfoamed composite of flock fibers and elastomer, wherein the foamed or unfoamed composite elastomer layers against the base elastomer layer and flock extends away from the base and composite elastomers,
wherein the flock fibers include hydrophobic fibers and hydrophilic fibers.

14. The lined elastomeric article of claim 13, wherein the elastomeric base layer is predominantly natural rubber.

15. The lined elastomeric article of claim 13, wherein the elastomeric base layer is predominantly NBR.

16. The lined elastomeric article of claim 13, wherein the elastomeric base layer is substantially CP, NBR or combinations thereof.

17. A method of making an lined elastomeric article of claim 13, comprising
applying to an elastomeric base layer a foamed or unfoamed composite of liner flock fibers and aqueous elastomer,
wherein the flock fibers include hydrophobic fibers and hydrophilic fibers.

18. The method of claim 17, wherein the elastomeric base layer is predominantly natural rubber.

19. The method of claim 17, wherein the elastomeric base layer is predominantly NBR.

20. The method of claim 17, wherein the elastomeric base layer substantially CP, NBR or combinations thereof.

21. The method of claim 17, further comprising treating the base layer with a primer prior to applying the fiber composite.
